(19) United States
(12) Patent Application Publication
(10) Pub. No.: US 2010/0156294 A1
(43) Pub. Date: Jun. 24, 2010

(54) DISCHARGE LAMP HAVING A CATHODE WITH CARBON SOLID-SOLVED IN A TUNGSTEN METAL SUBSTRATE OF THE CATHODE

(75) Inventors: Mitsuru IKEUCHI, Himeji-shi (JP); Tomoyoshi ARIMOTO, Himeji-shi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: USHIO DENKI KABUSHIKI KAISHA, Tokyo (JP)

(21) Appl. No.: 12/634,134

(22) Filed: Dec. 9, 2009

(30) Foreign Application Priority Data
Dec. 22, 2008 (JP) 2008-326218

(51) Int. Cl. H01J 61/06

(52) U.S. Cl. 313/632

(57) ABSTRACT

A discharge lamp having a cathode containing lanthanum oxide (La₂O₃) as an electron emission material, to provide a discharge lamp where reduction of lanthanum oxide (La₂O₃) is accelerated; a supply amount of lanthanum (La); and its lifespan is long has an anode (4) and a cathode (5) arranged within a discharge vessel (1) so as to face toward each other in a tube axis direction of the discharge vessel (1), and the cathode (5) is made from a material containing a metal oxide of lanthanum (La₂O₃) and a metal oxide of zirconium (ZrO₂) in a tungsten metal (W) substrate with carbon present as a solid solution in the tungsten metal (W) substrate forming the cathode (5).

### BACKGROUND OF THE INVENTION

1. Field of Invention

The present invention relates to a discharge lamp with a high load and high radiance, and relates to a discharge lamp using a material containing lanthanum (La) in the cathode material as an electron emission material.

2. Description of Related Art

In a discharge lamp where mercury is enclosed in the discharge space used as a light source for an exposure device used for an exposure process or a discharge lamp where xenon gas is enclosed in the discharge space used as a light source in a film projector, it is known that excellent electron emission characteristics can be obtained by incorporating lanthanum oxide (La₂O₃) as an electron emission material in a cathode consisting primary of tungsten (W). However, in the discharge lamp having a cathode containing lanthanum oxide (La₂O₃) as an electron emission material, there is the problem that lanthanum (La) evaporates and is dried out in an early stage because of the high-temperature load applied to the cathode at the time of operation, and stable discharge can no longer be maintained.

Then, in the technology disclosed in Japanese Patent Application Publication No. 2006-286236 and corresponding U.S. Pat. No. 7,569,994 B2, utilizing the fact that zirconium (Zr) and hafnium (Hf) more easily react with oxygen as compared to tungsten, it is described that formation of tungsten oxide can be prevented by mixing it with at least one metal oxide selected from these metals. This inhibits tungsten oxide with a low melting point from becoming a liquid phase at approximately the operation temperature of the cathode, and a stable electron emission material is supplied throughout a long time and stable discharge can be maintained for a long time.

In addition, an attempt to achieve improvement by adding an oxide or carbide is described in WO-A-03/075310 and corresponding U.S. Pat. No. 7,279,839 B2.

Although the evaporation and drying out of lanthanum (La) in an early stage can be prevented by mixing it with at least one type of metal oxide selected from zirconium (Zr) and hafnium (Hf), reduction of the electron emission material contained as lanthanum oxide (La₂O₃) to lanthanum is insufficient, and lanthanum (La) is still insufficient for the purpose of providing a discharge lamp with a long lifespan. When the amount of lanthanum (La) is insufficient, there are problems that the coverage factor of lanthanum (La) atoms (surface density of La atoms regarded as 1 at the time of coating with a mono-atomic layer) becomes smaller at the tip part of the cathode, and the work function becomes great and the cathode temperature is increased and the cathode becomes deformed, and flickering occurs.

### SUMMARY OF THE INVENTION

The present invention has been accomplished for the purpose of solving the problems mentioned above, and the object is to provide a discharge lamp having a cathode containing lanthanum oxide (La₂O₃) as an electron emission material, wherein reduction of the lanthanum oxide (La₂O₃) is accelerated and the supply quantity of lanthanum (La) is increased, and the lamp has a long lifespan.

A first aspect of the present invention is a discharge lamp that comprises an anode and a cathode arranged within a discharge vessel so as to face toward each other in a tube axis direction of the discharge vessel, and where the cathode is made from a material containing a metal oxide of lanthanum and a metal oxide of zirconium in a tungsten metal substrate, wherein carbon is present as a solid solution in the tungsten metal substrate forming the cathode.

A second aspect of the present invention is a discharge lamp wherein the cathode is composed of a tip part, a taper part and a barrel part, and the concentration of solid-solved carbon in the tip part is higher than that of solid-solved carbon in the taper part.

According to the discharge lamp relating to the first aspect of the present invention, the reduction of lanthanum oxide (La₂O₃) proceeds even at a site where the temperature does not comparatively become higher at the time of operating the discharge lamp and lanthanum (La) can be generated by incorporating carbon (C) as a solid solution into the cathode containing lanthanum oxide (La₂O₃) as an electron emission material. Compared to the case where no carbon (C) is solid-solved into the cathode, the portion which is the supply source of lanthanum (La) can be expanded, and the supply quantity of lanthanum (La) is increased, and thus, a discharge lamp with a long lifespan can be provided.

According to the discharge lamp relating to the second aspect of the present invention, a reduction reaction can be inhibited by increasing the concentration of carbon (C) at the tip part of the cathode, which reaches a high temperature at the time of operation, to increase the CO partial pressure in the vicinity of lanthanum oxide particles, and an outflow of lanthanum (La) is prevented and consumption at the tip part of the cathode can be inhibited. Further, since the temperature of the taper part in the cathode does not become so high even at the time of operation, the concentration of carbon (C) is decreased as compared to the tip part and the reduction reaction is accelerated. Lanthanum (La) generated at the taper part is diffused along the grain boundary of tungsten (W), and generation of flickering due to lack of lanthanum (La) is prevented. Preferably, the concentration of the solid-solver carbon at the tip part approximately 3 mm away from the surface is in the range of 20 to 100 wt.ppm and the concentration of the solid-solved carbon at the taper part approximately at least 3 mm away from the surface is in the range of 5 to 20 wt.ppm.

### BRIEF DESCRIPTION OF THE DRAWINGS

FIG. 1 is an explanatory schematic partial cross-sectional view showing a configuration in one example of the discharge lamp of the present invention.

FIG. 2 is an equilibrium diagram of tungsten (W) and carbon (C).

FIG. 3 schematically shows a portion where the ratio of carbon (C) is extremely small in the equilibrium diagram shown in FIG. 2.

### DETAILED DESCRIPTION OF THE INVENTION

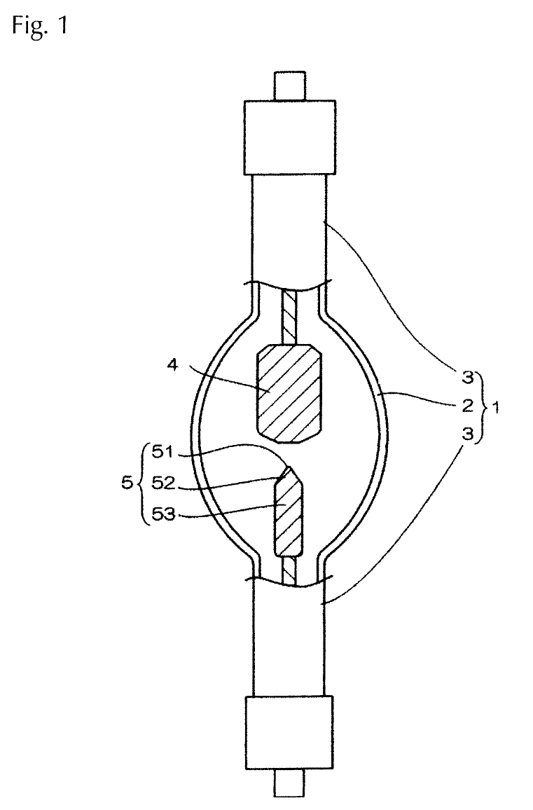

FIG. 1 is an explanatory cross-sectional view showing the configuration of a discharge lamp used as a light source for an exposure device, where mercury is enclosed in the discharge space, as one example of a discharge lamp of the present invention. Only the arc tube 2, which is a part of a discharge vessel 1, is illustrated broken away to show the configuration of the inside.

The discharge lamp is made of a light transparent material, such as quartz glass, and is equipped with the discharge vessel 1 having a roughly-spherical arc tube 2 and sealing tubes 3 continuously extending outward at opposite ends of the arc tube 2, an anode 4 and a cathode 5 made of, for example, tungsten (W), respectively, are placed facing toward each other in the tube axis direction of the discharge vessel 1 inside the discharge vessel 1. The cathode 5 has a tip part 51 arranged so as to face the anode 4, a taper part 52 whose diameter is decreased toward the tip part 51 and a cylindrical barrel part 53.

Predetermined quantities of mercury and buffer gas are enclosed in the internal space of the discharge vessel 1 as an emission material or starting aid gas, respectively. As the buffer gas, for example, xenon gas is enclosed. The filling quantity of mercury is, for example, within the range of 1 mg/cm³ to 70 mg/cm³, and the enclosed quantity of xenon gas is, for example, within the range of 0.05 MPa to 0.5 MPa, for example, 0.1 MPa.

In this discharge lamp, electrons emanate from the cathode 5 toward the anode 4 and dielectric breakdown occurs by applying high voltage, for example, 20 kV, between the anode 4 and the cathode 5, and subsequently, a discharge arc is formed and light containing an i-line with a wavelength of 365 nm or g-line with a wavelength of 435 nm is emitted.

The anode 4 is made of, for example, tungsten with a purity of 99.99 weight %, and the cathode 5 mainly contains tungsten, the content of tungsten being lower than 98 weight %. The tungsten metal substrate of this cathode 5 contains a metal oxide of lanthanum (La) as an electron emission material and another metal oxide of zirconium (Zr) as a stabilizing material to stabilize the electron emission material, and carbon (C) is present as a solid solution in the tungsten (W).

Lanthanum oxide (La₂O₃) contained in the cathode 5 is an electron emission material, and this is reduced and oxygen is removed. The lanthanum atoms move around in the tungsten and reach the tip part 51 of the cathode, and then, lanthanum is coated at the tip part 51 of the cathode 4 and a mono-atomic layer, electron emission cathode is formed. In other words, the work function of the cathode 5 becomes small, the operation temperature of the cathode 5 is lowered and the lifespan of the cathode 5 can be prolonged.

Zirconium oxide (ZrO₂) contained in the cathode 5 is a stabilizing material to stabilize the electron emission material, and tungsten oxide is formed and can be inhibited from becoming a liquid phase due to a decreasing melting point. Oxygen (O₂) generated by reducing lanthanum oxide (La₂O₃) reacts with tungsten (W) and produces tungsten oxide (WO₃) when there is no zirconium. Tungsten oxide (WO₃) forms a compound with a low melting point with lanthanum oxide (La₂O₃), and there is a problem that the transport rate of emitter is rapidly increased by becoming a liquid phase and the compound is consumed.

Consequently, zirconium oxide (ZrO₂) is added and zirconium (Zr), which easily forms an oxide as compared to tungsten (W), functions as an oxygen getter, and formation of tungsten oxide (WO₃) is inhibited. Since the compound with a low melting point will no longer be formed, formation of the liquid phase is inhibited at approximately the operation temperature of the cathode 5, and evaporation and drying out of lanthanum (La) in an early stage can be prevented.

Carbon (C) is contained in the cathode 5 not as a carbide formed with a metal element, but exists as an element in solid solution in the tungsten (W). Solid solution is a state where an original crystal structure is maintained and mixed as a solid state even if other atoms enter into the metallic crystal structure, and specifically, is an interstitial solid-solved body where carbon (C) with its small atomic radius enters into the gaps in between atoms of metallic crystal grains of tungsten (W).

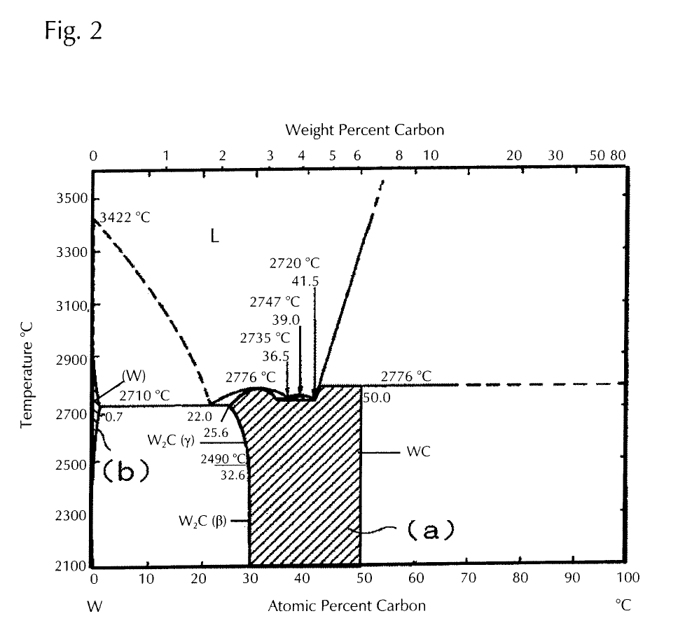

FIG. 2 is an equilibrium diagram between tungsten (W) and carbon (C). Reference: S. V. Nagender Naidu et al., Phase Diagrams of Binary Tungsten Alloys (Indian Institute of Metals, 1991) p. 37-50. The horizontal axis indicates the ratio of tungsten (W) and (C), and the vertical axis indicates temperature.

According to the equilibrium diagram, it is understood that the condition to mix carbon (C) varies according to the ratio of carbon (C) contained in tungsten (W). The lower portion from the center (a) in the graph shows a condition where the ratio of carbon (C) is 30% to 50% and the temperature is 2,700° C. or less, and where a carbide, which is a compound of tungsten (W) and carbon (C), such as tungsten carbide (WC), is produced. The left end portion (b) of the graph shows a condition where the ratio of carbon (C) is extremely small and the temperature is around 2,700° C., and the carbon (C) does not form a compound, but is solid-solved in the tungsten (W) and carbon (C) exists as a single unit. The condition under (b) is referred to as a solid-solved body, and two or more types of elements are dissolved with each other and the whole is a uniform solid phase.

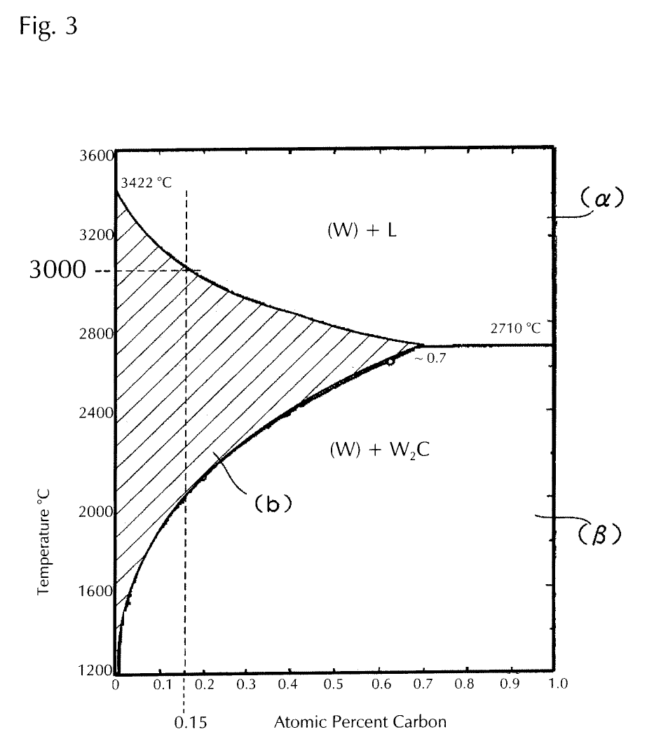

FIG. 3 is a graph where the part wherein the ratio of carbon (C) in the equilibrium diagram shown in FIG. 2 is extremely small is enlarged. Reference: S. V. Nagender Naidu et al., Phase Diagrams of Binary Tungsten Alloys (Indian Institute of Metals, 1991) p. 37-50.

The graph shows on the left side (b) the solid-solved phase where the ratio of carbon (C) is extremely small, on the upper right side (a) the state where the solid-solved phase and a liquid phase are mixed where the ratio of carbon (C) is comparatively great and the temperature is high, and on the lower right side (β) shows the state where the solid-solved phase and carbide are mixed where the ratio of carbon (C) is comparatively great and the temperature is low. When the ratio of carbon (C) becomes greater from the boundary between the state where the solid-solved phase and the liquid phase are mixed (a) and the solid-solved phase (b), the melting point becomes lowered. Since the vicinity of the tip part 51 of the cathode 5 reaches a high temperature of approximately 3,000° C. at the time of operation, it is necessary to reduce the mixing ratio of carbon (C) and not to melt the cathode 5 at the time of operation. In order not to melt the cathode 5 even at the time of operating the discharge lamp, it is clear from the equilibrium diagram that the carbon concentration has to be 100 wt.ppm (approximately 0.15 wt. %) or less.

When the configuration where carbon (C) is present as a solid solution in a tungsten metal substrate is applied for the cathode 5 and tested, the lifespan of the discharge lamp is improved. As a reason why the lifespan is improved, it is assumed that the phenomenon mentioned below occurs.

Carbon (C) solid-solved into tungsten (W) causes a reaction with lanthanum oxide (La₂O₃) similarly contained in the tungsten (W), and lanthanum oxide (La₂O₃) is reduced.

La₂O₃+3C⇄2La+3CO

A single body of lanthanum (La) generated by reduction diffuses through the crystal grain boundary of tungsten (W) and travels to the tip part 51 of the cathode 5. In the meantime, carbon monoxide (CO) generated in the reduction reaction exists as gas in the void where grains of oxides including lanthanum oxide (La₂O₃) exist in the tungsten (W). When the reduction of lanthanum oxide (La₂O₃) proceeds, the quantity of carbon monoxide (CO) is also increased, and the pressure of carbon monoxide (CO) in the voids becomes higher. In this state, carbon monoxide (CO) split into carbon (C) and a oxygen (O) by making contact with tungsten (W), and each is solid-solved in the tungsten (W).

Since carbon (C) is repeatedly used due to such a secondary reaction (CO⇄C+O), lanthanum oxide (La₂O₃) can be sufficiently reduced even with a small amount. Further, since oxygen (O₂) generated due to the reduction of lanthanum oxide (La₂O₃) reacts with carbon and gives carbon monoxide (CO), it prevents the formation of tungsten oxide (WO₃), and lanthanum (La) will not evaporate and dry out in an early stage.

Since carbon (C) does not exist in the form of carbide where a compound is formed with a metal element but in a single body solid-solved in the tungsten (W), it is unnecessary to generate elemental carbon (C). When carbon (C) is used as a reductant, because energy required for generating carbon (C) is no longer required, the reduction reaction of lanthanum oxide (La₂O₃) occurs even at a section where the temperature is comparatively low.

Further, when carbon (C) is contained in the form of a carbide, the carbide is non-uniformly located in specific portions of the cathode 5. However, if carbon (C) is present as a solid solution, carbon (C) is uniformly distributed in a small quantity throughout the cathode 5. Therefore, carbon (C) is close to the lanthanum oxide (La₂O₃) which exists in any portion of the cathode 5, and the reduction reaction of lanthanum oxide (La₂O₃) can proceed without any interruption.

The reduction of lanthanum oxide (La₂O₃) proceeds even at a site where the temperature does not become comparatively high at the time of operating the discharge lamp by solid-solving carbon (C) into the cathode 5 containing lanthanum oxide (La₂O₃) as an electron emission material, and lanthanum can be produced. Compared to the case where no carbon (C) is solid-solved in the cathode 5, the portion to be a supply source of lanthanum (La) can be expanded, and the supply quantity of lanthanum increased and a discharge lamp with a longer lifespan can be provided.

When lanthanum oxide (La₂O₃) is used as an electron emission material, in the prior art, because the reduction does not sufficiently proceed, lanthanum (La) is insufficient and the temperature at the end of the cathode 5 is increased. Therefore, a large-sized discharge lamp requiring a large quantity of power cannot be adopted. However, if carbon (C) and oxygen (O) are added to the anode 4 and carbon (C) is diffused into the cathode 5, even if lanthanum oxide (La₂O₃) is used as an electron emission material for a large-sized discharge lamp requiring a large quantity of power, lanthanum (La) can be sufficiently supplied.

Further, when the cathode 5 is configured so that the concentration of solid-solved carbon solved into the tip part 51 exceeds the concentration of solid-solved carbon in the taper part 52, tests show that the lifespan of the discharge lamp is further improved. As a reason for the improvement, occurrence of a phenomenon mentioned below is assumed.

The higher the pressure of carbon monoxide (CO) existing as gas between crystal and crystal becomes, the higher the concentration of carbon (C) and oxygen (O) solid-solved in lanthanum oxide (La₂O₃). Since the reduction of lanthanum oxide expressed with the chemical reaction formula: La₂O₃+3C⇄2La+3CO is an equilibrium reaction, the higher the concentration of carbon monoxide (CO) is, the more the reduction reaction of lanthanum oxide in tungsten (W) is inhibited, and outflow of lanthanum (La) as an emitter is prevented.

The higher the concentration of carbon (C) solid-solved in tungsten (W) is, the more the partial pressure of carbon monoxide (CO) is increased, and the reduction reaction of lanthanum oxide (La₂O₃) is inhibited. Since the reduction reaction of lanthanum oxide also depends upon the temperature, the reduction reaction is inhibited by increasing the concentration of carbon (C) in the tip part 51 of the cathode 5, which reaches a high temperature at the time of operation, and the outflow of lanthanum (La) is prevented and consumption of the tip part of the cathode 5 can be prevented. Further, since the taper part 52 of the cathode 5 around the periphery of the tip part 51 of the cathode 5 does not have such a high temperature even at the time of operation, the concentration of carbon (C) is reduced as compared to the tip part 51 and the reduction reaction is accelerated. Lanthanum (La) produced at the taper part 52 is diffused along the grain boundaries of tungsten (W) and supplied to the tip part 51 of the cathode 5, and flickering due to lack of lanthanum (La) is prevented.

Subsequently, a method for manufacturing the cathode where carbon (C) is solid-solved in tungsten (W) is explained.

Tungsten, which is the cathode material, is formed by a powder-metallurgical method. First, powders whose average particle sizes are different from each other are mixed so as to have an appropriate particle size distribution in the prepared tungsten powder; a binder, such as stearic acid, is added; the mixture is filled in a mold; pressure forming is conducted; and a rod-shaped compact is obtained. Subsequently, the temperature is gradually increased in hydrogen and the binder escapes, and the temperature is further increased and a temporarily-sintered body is obtained. On that occasion, if the dew point of hydrogen is low, because the residual amount of binder-derived carbon (C) is increased, the doping amount of carbon (C) can be adjusted by adjusting the dew point of hydrogen.

Furthermore, if the dew point of hydrogen is maintained low and the residual amount of binder-derived carbon (C) is increased and wet hydrogen with a high dew point is added in the final stage of temporary sintering, the residual carbon (C) in the vicinity of the surface of the cathode can be removed and a temporarily-sintered body with high carbon concentration in the vicinity of the center and low carbon concentration toward the surface can be obtained.

In addition, a sintered rod can be obtained by electric current sintering the temporarily-sintered body in hydrogen. The quantity of carbon (C) contained in the tungsten (W) is decreased in the process of sintering. Since the decrease ratio is changed according to the particle size distribution of the material powder, superficial density of the temporarily-sintered body, sintering temperature (flowing current), and sintering time, by regulating the dew point of hydrogen and by adding an excess amount at the time of temporarily sintering according to the decrease ratio a tungsten sintered rod having the desired amount of carbon can be obtained.

Further, the carbon concentration to be solid-solved into the tip part 51 can be increased by adding carbon through discharge. After the cathode shape is finished, a discharge is produced at the tip part of the cathode in an argon atmosphere at atmospheric pressure, and the electric current is adjusted so as to adjust the end temperature at approximately 2,500 K. Then, gas is switched to one where 13 Pa or less of methane is mixed into argon, and discharging is maintained for approximately 1 hour. The carbon concentration to be solid-solved can be increased at approximately 3 mm of the tip part 51 by this process.

Subsequently, an assay method for verifying that carbon (C) is solid-solved in the tungsten (W) cathode material, is explained.

According to the equilibrium diagram shown in FIG. 3, when carbon (C) is contained in the tungsten (W) and the quantity is 100 wt. ppm or less, carbon (C) does not form a carbide at any temperature, and it can be stated that carbon (C) is solid-solved in the tungsten (W). Therefore, the tungsten (W) cathode material is analyzed and if it is confirmed that the tungsten (W) contains carbon (C), and the quantity is 100 wt. ppm or less, it can be stated that carbon (C) is solid-solved in the tungsten (W).

A suitable assay method for detecting the quantity of carbon (C) contained in the tungsten (W) is that according to Japan Tungsten & Molybdenum Industries Association, Tungsten and Molybdenum Assay Method 16: Total Carbon Quantitative Determination Method. As the quantitative determination method for total carbon, a) burning—dielectric constant method, b) burning—electricity method, c) burning—electrothermal conductivity method, d) burning—infrared ray absorption method (integral technique), and e) burning—infrared ray absorption method (cyclic method) are exemplified, and any of them is acceptable.

Herein, a) burning—dielectric constant method is explained.

The cathode 5 is ground and tungsten powder is obtained as a sample; the sample is heated in an oxygen air flow; carbon is oxidized and carbon dioxide is obtained; carbon dioxide is absorbed to a constant quantity of sodium hydroxide solution; and the change in conductivity of the solution before and after the absorption is measured. Then, the content of carbon can be obtained.

Furthermore, regarding the discharge lamp shown in FIG. 1, where the use of mercury was explained, in a discharge lamp where the enclosed gas is changed to only xenon gas instead of mercury for a light source in a projector, the cathode of the present invention where carbon (C) is solid-solved can also be used.

An embodiment of the present invention will now be described.

### Experimental Example

A xenon short arc lamp was manufactured using a cathode where carbon is solid-solved in a material containing a metal oxide of lanthanum and a metal oxide of zirconium in a tungsten metallic substrate, and the lamp pressure was measured at the time of operation up to 1,000 hours.

The configurations of the cathode and the xenon short arc lamp are as follows:

### <Specifications>

Enclosed gas: xenon (Xe) 0.65 MPa (static pressure)

Input: 2 kW

Cathode: axial length: 15 mm, external diameter of barrel part: 6 mm, angle of taper part: 40°, main component: tungsten, 2 wt. % of La₂Zr₂O₇ added

As Experimental Object 1, a cathode made of a material where carbon with a concentration of approximately 10 wt.ppm was solid-solved into tungsten was prepared. As Experimental Object 2, a cathode made of a material with carbon solid-solved into tungsten having a carbon concentration at the tip part approximately 3 mm away from the surface of approximately 50 wt.ppm and a carbon concentration at the taper part approximately 3 mm or more away from the surface of approximately 10 wt.ppm was prepared. Further, as a comparative example, a cathode made of a material where no carbon was solid-solved into tungsten was prepared.

The lamp pressure at the time of using each cathode was compared using a coefficient of voltage fluctuation. The point of reaching a stationary state after illumination was regarded as a starting point, and the voltage coefficients of fluctuation were measured when the continuous operation time period was 100 hours (100 h), 200 hours (200 h), 500 hours (500 h) and 1,000 hours (1,000 h) from the starting point. Herein, the coefficient of voltage fluctuation is a value where the difference between a maximum value and a minimum value in a voltage waveform for 10 seconds was divided by a mean value.

The test results are shown in Table 1.

TABLE 1

| | 0 h | 100 h | 200 h | 500 h | 1,000 h |
|---|---|---|---|---|---|
| Experimental Object 1 | 1.2% | 1.3% | 1.4% | 1.5% | 2.2% |
| Experimental Object 2 | 1.3% | 1.2% | 1.5% | 1.4% | 1.7% |
| Comparative Example | 1.3% | 1.2% | 3.2% | 5.1% | 8.3% |

A xenon lamp is used as a light source in a projector, and when the illuminance fluctuation becomes greater, because flickering appears on the picture surface, the lamp lifespan is set using the illuminance fluctuation as a standard. The coefficient of voltage fluctuation can be used as an alternative characteristic of the illuminance fluctuation, and when the coefficient of voltage fluctuation exceeds 5%, the illuminance fluctuation becomes greater and this is determined that the lamp lifespan is over.

According to this standard, the lifespan of the xenon lamp in the comparative example is approximately 500 hours, and the lifespan of Experimental Objects 1 and 2 having a cathode where carbon is solid-solved is 1,000 hours or longer. In the xenon lamp of Experimental Object 2 where the carbon concentration especially at the tip part is increased, the coefficient of voltage fluctuation is maintained low even after 1,000 hours of illumination, and it is assumed that this is a xenon lamp with a longer lifespan.

What is claimed is:

1. A discharge lamp, comprising:
a discharge vessel,
an anode and
a cathode,
wherein the anode and cathode are arranged within the discharge vessel facing toward each other in a tube axis direction of the discharge vessel,
wherein the cathode is made of a material containing a metal oxide of lanthanum and a metal oxide of zirconium in a tungsten metal substrate, and
wherein carbon is present as a solid solution in the tungsten metal substrate forming the cathode.

2. The discharge lamp according to claim 1, wherein the cathode is composed of a tip part, a tapered part and a barrel part, and wherein the solid-solved carbon has a concentration in the tip part that is higher than that of solid-solved carbon in the tapered part.

3. The discharge lamp according to claim 2, wherein the concentration of the solid-solved carbon at the tip part approximately 3 mm away from the surface is in the range of 20 to 100 wt.ppm and the concentration of the solid-solved carbon at the taper part approximately at least 3 mm away from the surface is in the range of 5 to 20 wt.ppm.

4. The discharge lamp according to claim 1, wherein the lamp is a xenon discharge lamp having xenon gas disposed in the discharge vessel.
